(19) United States
(12) Patent Application Publication
(10) Pub. No.: US 2004/0033853 A1
(43) Pub. Date: Feb. 19, 2004

(54) Chain and sprocket transmission system for small all-terrain vehicles

(75) Inventors: Steven J. Patmont, Pleasanton, CA (US); Robert McDermott, Livermore, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Patmont Motor Werks, Pleasanton, CA

(21) Appl. No.: 10/219,921

(22) Filed: Aug. 14, 2002

(51) Int. Cl. F16H 7/08; B62J 13/00; F16H 57/02

(52) U.S. Cl. 474/140; 474/111; 474/144

(57) ABSTRACT

A chain and sprocket transmission system for small all-terrain vehicles couples a high-speed, low-horsepower motor to a small diameter ground-engaging vehicle driving wheel. The chain and sprocket transmission system includes a small driving sprocket directly driven by the high-speed, low-horsepower motor. A large driven sprocket coaxially rotates with the small-diameter ground-engaging wheel. An endless chain has links for encircling in a loop the small driving sprocket and the large driven sprocket for powering the small-diameter ground-engaging wheel. A chain keeper pivots over the small driving sprocket. This chain keeper has a chain-contacting tongue elastically biased with respect to the keeper toward the inside of the chain loop. The chain-contacting tongue contacts and tensions the chain at the idle chain linkage between the small driving sprocket and the large driven sprocket.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

This invention relates to a chain drive and a chain transmission system for small all-terrain vehicles, such as motorized scooters or motorized carts. More particularly, a chain drive which effects high reduction between a high-speed, low-horsepower motor and a slower speed, driven small-diameter ground-engaging wheel is disclosed. A unique chain keeper acts as a tensioner, lubricator, guard and guide, enabling the system use of a small-size chain and sprocket drive having low inertia and high speed reduction between the motor and driven wheel.

### BACKGROUND OF THE INVENTION

Chain drives for small all-terrain vehicles, such as scooters and go carts, are replete with problems. First, such vehicles operate in a dirt and mud environment. The resultant ambient grit produces high chain wear with resultant chain lengthening.

Chain lengthening due to chain wear can be easily understood. In the case of a chain having 94 links, chain wear for each link will occur at three separate places. First, each link is held together by a link pin. As the pin diameter decreases due to wear, the overall length of the link will increase in each chain direction by the amount of the wear. Second, each chain link includes forward-extending links and rearward-extending links. Each of these respective forward-extending and rearward-extending links fastens to the link pin at an aperture. Each of these apertures is subject to wear, especially in the grit environment. Each aperture as it is subject to wear becomes an individual contributor to chain lengthening.

Because there are two apertures for each pin at each link, the chain wear at each aperture will contribute to chain lengthening. Thus, in the chain having 94 links, there are additively 94 pins and 188 apertures all subject to wear. Each wear point, being a pin or an aperture, lengthens the chain. Presuming that the small all-terrain vehicles are continually operated in a grit environment, adjustment for chain length change becomes an ongoing proposition.

A rapidly lengthening chain on a small all-terrain vehicle increases the probability of chain and sprocket derailment. Generally speaking, the smaller the chain, the more rapid the wear.

It is known to use mechanical tensioning devices in such environments. However, such conventional mechanical tensioners require pivot points, spring bias, and chain idlers. They impose a considerable complication on a chain and sprocket drive. In the case of a small all-terrain vehicle, further complication of mechanical tensioning devices is disadvantageous, especially in the limited space available between the driving low-horsepower, high-speed motor and the sprocket-driven small-diameter ground-engaging wheel.

Small all-terrain vehicles typically use low-horsepower, high-speed motors. For example, in the scooter which forms a preferred example of this invention, a 2-½ horsepower 8000 rpm motor is used. This motor is used to drive wheels in the order of eight to nine inches. Rotation reduction is a key transmission system issue.

At the same time, small all-terrain vehicles place high dynamic loading on their transmissions. For example, where the wheels of such vehicles temporarily leave the ground and become airborne, return of the powered wheel to the ground normally produces high dynamic shock loads on the transmission system. As a result, many chain transmission systems have tried using chain sizes that can withstand the high dynamic shock loads. Unfortunately, with increased chain size, sprocket size and sprocket inertia increases. Increased sprocket size necessitates the use of a larger transmission system, requires the use of intermediate so-called idler or “jack” shafts, and increases transmission inertia, inhibiting acceleration and deceleration.

Intermediate idler or “jack” shafts present an especially undesired complication to chain and sprocket transmission systems for small all-terrain vehicles. In such idler or jack shafts systems, a first chain loops the high-speed drive sprocket at the low-horsepower motor to a second driven sprocket on the idler or jack shaft. A second chain loops the third drive sprocket on the idler or jack shaft and extends to a fourth driven sprocket at the small ground-engaging wheel. The additional mechanical parts of the idler or jack shaft and two sprockets, the additional second chain, the complexity of mounting the idler or jack shaft and the two sprockets, and the space required for such idler or jack shaft and two sprockets are generally unsuitable for small all-terrain vehicle chain transmissions.

Presuming that one wishes to use a small-size chain and sprocket drive for an all-terrain vehicle, the load limits of such small chains also become a problem. For example, a No. 25 chain has a tensile load limit in the order of 900 pounds (compared to the 2500-pound tensile load limit of the No. 35 chain). With normally available chain and sprocket transmissions, a lighter chain realizes greater probability of chain failure.

Finally, and presuming that one is going to use small chain for such an all-terrain vehicle high-reduction chain and sprocket transmission, the transmission of power from a small high-speed sprocket to the small chain presents a power transmission issue. By definition, a small-diameter sprocket contacts the chain at a small number of lugs. Where the total power of the engine is delivered to a small chain at a reduced number of lugs, the probability of load failure and chain failure increases directly proportional to the increased power transfer at each sprocket lug to each chain link.

### BRIEF SUMMARY OF THE INVENTION

A chain and sprocket transmission system for small all-terrain vehicles couples a high-speed, low-horsepower motor to a small diameter ground-engaging vehicle driving wheel. The chain and sprocket transmission system includes a small driving sprocket directly driven by the high-speed, low-horsepower motor. A large driven sprocket coaxially rotates with the small-diameter ground-engaging wheel. An endless chain has links for encircling in a loop the small driving sprocket and the large driven sprocket for powering the small-diameter ground-engaging wheel. A chain keeper pivots over the small driving sprocket. This chain keeper has a chain-contacting tongue elastically biased with respect to the keeper toward the inside of the chain loop. The chain-contacting tongue contacts and tensions the chain at the idle chain linkage between the small driving sprocket and the large driven sprocket. In the case of the small driving sprocket, chain contact with the small driving sprocket is increased to enable power transmission and distribution over an increased number of sprocket lugs and chain links. Preferably, the chain keeper is a one-piece construction, preferably molded from a high-impact, wear-resistant, low-chain-slide-friction plastic material. This molded chain keeper has a rigid section along the tension side of the chain, the pivot mounting to the small driven sprocket, and the chain-contacting tongue elastically biased with respect to the rigid section of the keeper across the pivot mounting. The one-piece chain keeper defines a groove for maintaining chain and sprocket alignment. The molded chain keeper acts as a chain guard protecting both the chain and the vehicle operator. Further, the one-piece chain keeper has an aperture through which lubricant can flow to the chain during power transmission. There results the chain and sprocket transmission system with a one-piece chain keeper that provides a chain tensioner, a chain lubricator, a chain guide, and a chain guard.

### BRIEF DESCRIPTION OF THE DRAWINGS

FIG. 1 is a perspective view of a rider on a scooter having the chain transmission system of this invention;

FIG. 2 is an enlarged side perspective view taken above and to the side of the small-diameter, high-speed-motor-driven sprocket and the large-diameter, ground-engaging wheel driving sprocket illustrating the placement of the chain keeper of this disclosure;

FIG. 3 is a side elevation of the one-piece integrally molded chain keeper of this transmission system illustrating in phantom the lubrication aperture and lubrication pouch;

FIG. 4 is a side elevation of the keeper pivoted in a first position about the small high-speed driving sprocket to supply tension to the idle section of the chain when the chain is of a first length; and

FIG. 5 is a side elevation of the keeper pivoted in a second position about the small high-speed driving sprocket to supply tension to the idle section of the chain when the chain is of a second and longer length.

### DETAILED DESCRIPTION OF THE INVENTION

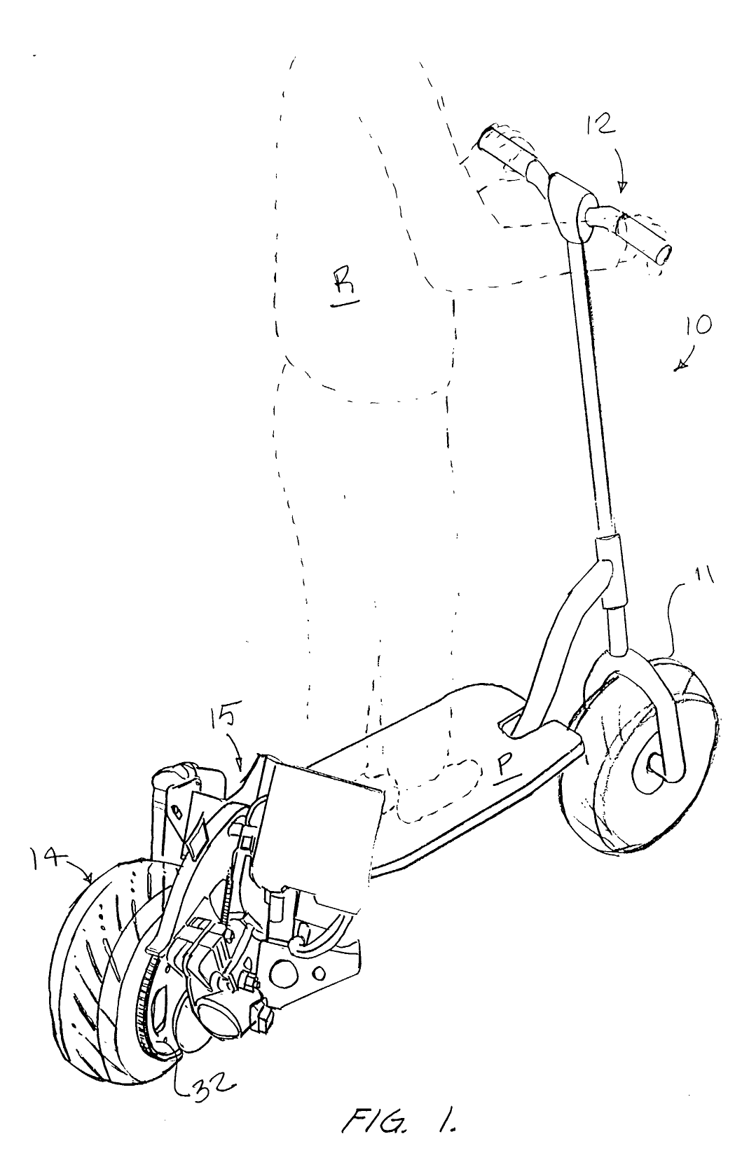

Referring to FIG. 1, rider R (shown in broken lines) stands upon scooter platform P steering scooter 10 at steering handle 12 to direct steered front wheel 11. Engine 15 powers rear driven wheel 14 to propel scooter 10 as directed by rider R.

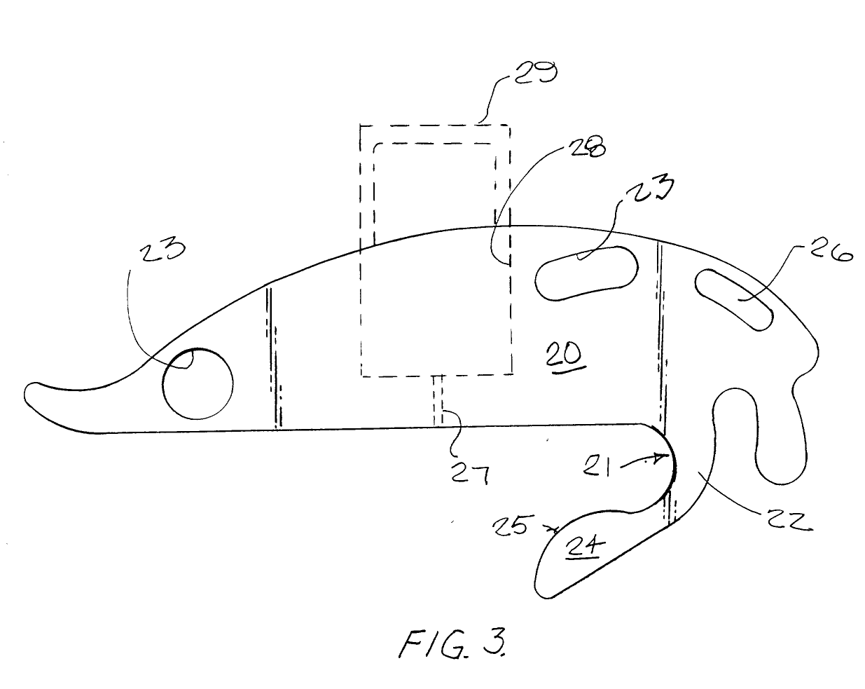

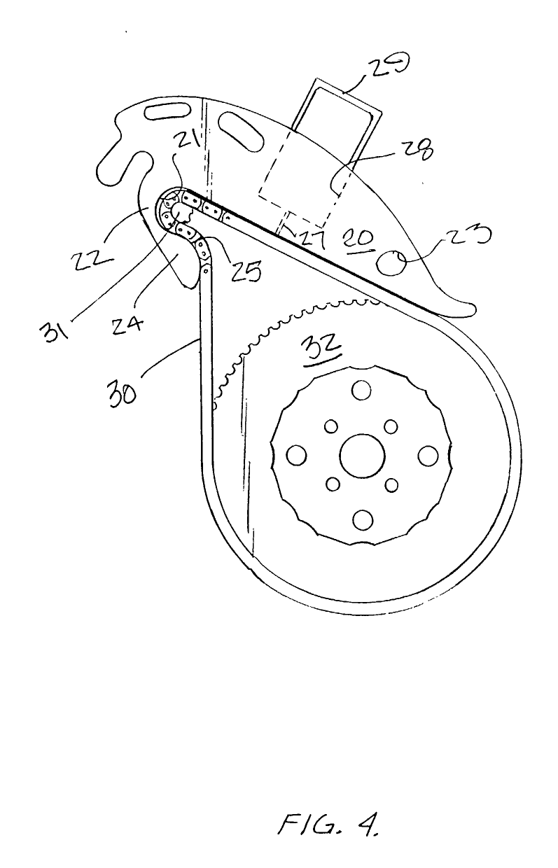

Referring to FIGS. 3 and 4, chain keeper 20 is illustrated in side elevation. Engine driven sprocket cavity 21 is the point of rotation for mounting rotating chain keeper 20 about engine driven sprocket 31. Chain keeper 20 is mounted at over center lock 40 at over center lock slot 26. Between mounting at the engine driven sprocket cavity 21 and the over center lock slot 26, chain keeper 20 is maintained in fixed relation about engine driven chain sprocket 31 and chain 30.

Typically, engine driven sprocket 31 has eight or nine lugs and is designed to fit to a No. 25 chain. Engine driven sprocket 31 turns at relatively high speed. It is common for the sprocket to rotate at 8000 rpm. Thus, it will be understood the chain 30 in its interaction with driven sprocket 31 passing around the wheel driving sprocket 32 is in effect a speed reduction system.

Continuing on with FIG. 3, an elastic bridge section 22 enables tongue 24 to be biased at chain depressing surface 25 against chain 30. It will be understood that once chain keeper 20 is angularly adjusted about engine driven sprocket 31, tongue 24 at chain depressing surface 25 will cause chain 30 to maintain a substantially constant tension.

Over center lock slot 26 enables keeper 20 to pivot about engine driving sprocket cavity 21. As will hereinafter be set forth, this pivot allows tongue 24 to be biased at chain contacting surface 25 to maintain chain 30 under proper tension at all times.

It will be remembered that scooter 10 operates in what is essentially a gritty environment. This being the case, constant lubrication is desirable. To this end, a lubricant pouch 29 is placed within a pouch-receiving cavity 28 and discharges lubricating fluid for chain 30 through aperture 27 on to the underlying chain. Since the chain is gathered from underlying aperture 27 to and toward engine driving sprocket cavity 21, keeper 20 serves to lubricate chain 30.

Additionally, it will be noted that pouch 29 protrudes above keeper 20. In such protrusion, pouch 29 is in a position where it may be readily activated by the foot of rider R. Accordingly, lubrication can be placed upon chain 30 even while scooter 10 is being operated (or even raced).

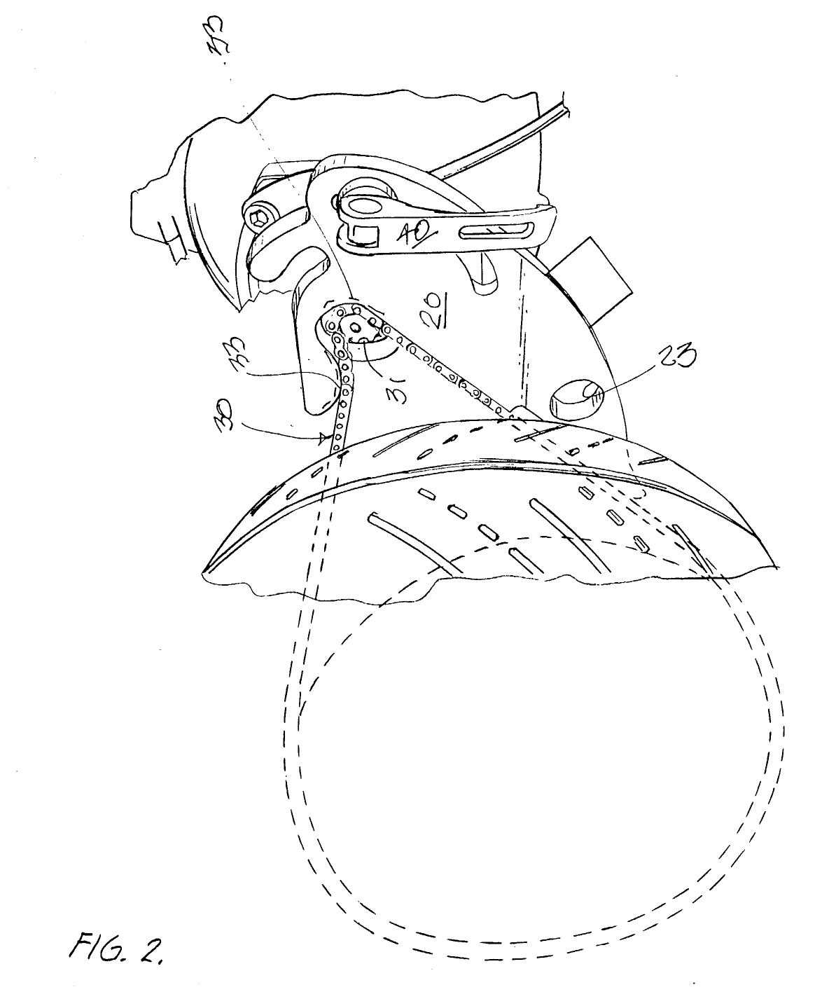

Finally, keeper 20 has handholds 23, which enabled the keeper to be pivoted about engine driving sprocket cavity 21. As will hereinafter become more apparent, when chain 30 undergoes wears and elongates, over center lock 40 is released (see FIG. 2). Thereafter, keeper 20 is grasped at one of the handholds 23 and pivoted upwardly about engine driven sprocket 31 to cause tongue 24 to exert pressure on chain 30. This enables constant tension to be maintained on chain 30 even though the chain substantially and rapidly elongates during use.

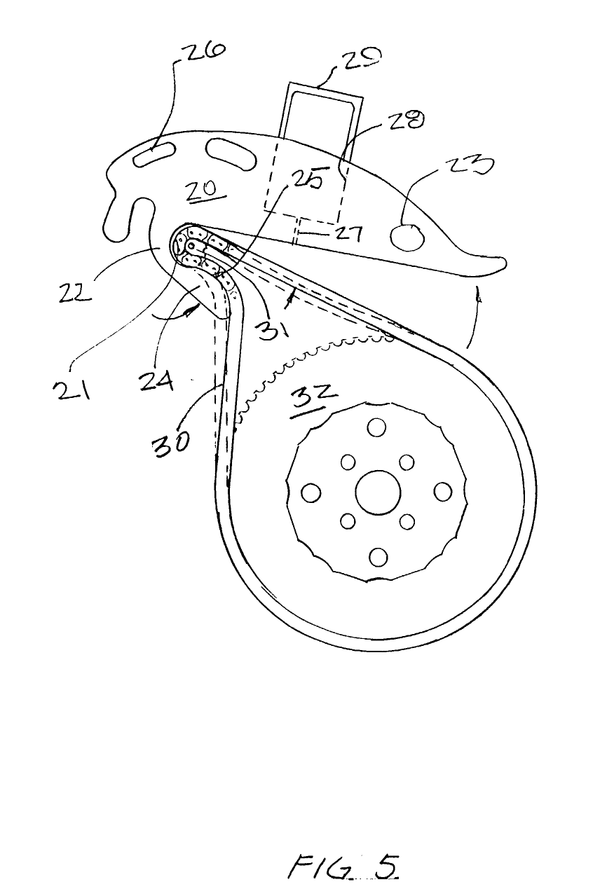

The action of keeper 20 in maintaining proper tension on chain 30 can be best understood with respect to the cartoon series of FIGS. 4 and 5.

Referring first to FIG. 4, a No. 25 chain is shown disposed around wheel driving sprocket 32 and engine driven sprocket 31. It will be seen that keeper 20 is parallel to chain along its major surface to and until chain 30 reaches engine driven sprocket cavity 21. Upon reaching engine driven sprocket cavity 21, chain 30 passes over chain depressing tongue 24 at chain contacting surface 25.

It will be understood that chain 30 is under tension between wheel driving chain sprocket 32 and engine driven chain sprocket 31. At engine driven chain sprocket 31, power from engine E will be transmitted from sprocket teeth on engine driven chain sprocket 31 to chain 30. This power will supply the tension at chain 30.

At the same time, when chain 30 leaves engine driven sprocket 31 and returns to wheel driving sprocket 32, tension on chain 30 will be practically nonexistent. Consequently, there is a need to apply tension to the chain 30. This function is served by chain depressing tongue 24 at chain contacting surface 25. It will be understood that without tension, chain 30 could well derail from wheel driving sprocket 32 as chain 30 is gathered to that sprocket.

Referring to FIG. 5, chain 30 has been subject to elongation. Most probably, such elongation will occur from operation of the chain in a gritty environment. It will be seen that chain keeper 20 has been rotated about engine driven sprocket 31 in an upwards direction. This has caused chain-depressing tongue 24 to contact chain 30 at chain contacting surface 25. In such contact, chain 30 has been disposed or wrapped around engine driven sprocket 31 along an extended periphery of the sprocket 31.

The individual functions of the chain 30 and chain keeper 20 will now be set forth.

First, chain 30 is maintained under tension. As chain 30 is gathered from the wheel driving sprocket 32 to and towards engine driven sprocket 31, this section of chain immediately underlying lubricating aperture 27 is linearly disposed because of the ambient tension upon the chain. At engine driven sprocket 31, the power of the engine is transmitted to the links of the chain 30. Typically, there is a total of eight or nine chain engaging lugs at engine driven sprocket 31. As the total power of the engine is delivered to chain 30 by this relatively small engine driven sprocket 31, a correspondingly small number of lugs on the sprocket transmits power to the links of the chain. By ensuring that the chain contacts a maximum number of lugs on the relatively small sprocket 31, the danger of breaking the chain at any one of the links or damaging the sprocket at any one of the lugs is vastly reduced. As can be seen in the view of FIG. 5, as compared to the view of FIG. 4, adjustment of the chain keeper 20 causes chain 30 to wrap about engine driven sprocket 31 at greater angularity as chain 30 wears and elongates.

Second, keeper 20 functions as a chain lubricator. It will be seen in the views of FIG. 4 and FIG. 5, chain 30 proceeds from under lubricant channel 27 to and toward engine driven sprocket cavity 21. Any oil deposited on chain 30 will be impelled upon engine driven sprocket cavity 21 and chain-depressing tongue 24 at chain depressing tongue surface 25. Consequently, lubrication will be ensured.

Third, chain keeper 20 functions as a chain guard. Should chain 30 part, the presence of guard 20 will prevent the bitter end of the chain from whipping or otherwise injuring the driver.

Forth, chain keeper 20 will wear at its points of contact with chain 30. Typically, chain keeper 20 is made from a hard plastic, such as nylon or UHMW, to enable sliding of the chain with respect to chain keeper 20. Such sliding will cause the hard plastic of the chain keeper 20 to be worn with a chain-guiding groove. Such a groove, especially at chain depressing tongue 24 in the vicinity of chain depressing tongue surface 25 will guide chain 30 to and toward wheel driving sprocket 32, preventing derailment of chain 30 as it is fed towards wheel driving sprocket 32. This groove, at depressing tongue 24, is highly desirable; accordingly chain keeper 20 may be manufactured with the groove preformed in the chain keeper.

Fifth, it will be understood that chain 30 and its respective sprockets 31, and 32 are all essentially light and relatively inexpensive. They can be replaced at minimal cost at relatively frequent intervals. For example, where the scooter 10 is raced, engine driven sprocket 31 and chain 30 can be replaced at the beginning of each race.

Typically, the No. 25 chain utilized with this invention has a maximum tensile force in the range of 900 pounds. Engine E is typically coupled to engine driven sprocket 31 by a conventional centrifugal clutch. As the speed of engine E increases, the conventional centrifugal clutch engages. At the same time, when driven wheel R momentarily leaves the ground and then suddenly re-engages with the ground, the conventional centrifugal clutch will slip and serve to absorb any shock, which might exceed the tensile limit of chain 30.

Some specifics about chain 30, engine driven sprocket 31, and wheel driving sprocket 32 can be instructive. The chain 30, being a No. 25 chain, has approximately 94 separate links with approximately 188 apertures. Thus, there are 248 possible points in chain 30 where elongation of the chain can and does occur.

Second, engine driven sprocket 31 has only six to nine lugs with about five of these respective lugs being in contact with the links of chain 30 at any given time. Total power transmission will occur between those lugs and chain links that are in contact with one another around engine driven sprocket 31. Thus, to avoid total power transmission between less than five of these respective lugs and a less than five of these respective links, tongue 24 at chain contacting tongue surface 25 is needed.

Third, wheel-driving sprocket 32 at the point where it gathers chain 30, is an ideal place for chain derailment to occur. Thus the guiding function of any grooves formed within chain keeper 20 can be critical, especially as chain 30 elongates.

What is claimed is:

1. A chain and sprocket transmission system for small all-terrain vehicles including a high-speed, low-horsepower motor coupled to a small-diameter vehicle driving wheel, the chain and sprocket transmission system comprising:
a small driving sprocket directly driven by the high-speed, low-horsepower motor;
a large driven sprocket coaxially rotating with the small-diameter vehicle driving wheel;
an endless chain having links for encircling in a loop the small driving sprocket and the large driven sprocket; and
a chain keeper for pivoting over the small driving sprocket having a chain-contacting tongue elastically biased with respect to the keeper for tensioning the chain at the idle chain linkage between the small driving sprocket and the large driven sprocket.

2. The chain and sprocket transmission system according to claim 1 and including:
a chain keeper lock for enabling the pivoting chain keeper to be pivotally locked to a position of rotation about the small driving sprocket whereby the chain-contacting tongue elastically biased with respect to the keeper can be adjusted in its bias with respect to the chain.

3. The chain and sprocket transmission system according to claim 1 and including:
a clutch connected between the small driving sprocket and the high-speed, low-horsepower motor for absorbing dynamic shock transmitted from the large driven sprocket.

4. The chain and sprocket transmission system according to claim 1 and including:
a lubricant source disposed in the chain keeper for lubricating the endless chain.

5. The chain and sprocket transmission system according to claim 4 and wherein:
the lubricant source is disposed in a tensioned portion of the chain keeper between the large driven sprocket and the small driving sprocket.

6. The chain and sprocket transmission system according to claim 1 and wherein:
the chain keeper is a single molded plastic piece.

7. The chain and sprocket transmission system according to claim 1 and wherein:
the chain keeper includes a groove for maintaining the side-to-side alignment of the chain with respect to the sprockets.

8. The chain and sprocket transmission system according to claim 1 and wherein:
the chain-contacting tongue elastically biases the chain to the inside of the loop whereby the encircling in a loop of the small driving sprocket is increased.

9. A chain and sprocket transmission system for small all-terrain vehicles including a high-speed, low-horsepower motor coupled to a small diameter vehicle driving wheel, the chain and sprocket transmission system comprising:
a small driving sprocket directly driven by the high-speed, low-horsepower motor;
a large driven sprocket coaxially rotating with the small-diameter vehicle driving wheel;
an endless chain having links for encircling the small driving sprocket and the large driven sprocket; and
a one-piece chain keeper for pivoting over the small driving sprocket having a chain-contacting tongue elastically biased with respect to the keeper for tensioning the chain at the idle chain linkage between the small driving sprocket and the large driven sprocket.

10. The chain and sprocket transmission system of claim 9 and further wherein the one-piece chain keeper includes:
a rigid section disposed adjacent to a tensioned portion of the endless chain between the large driven sprocket and the small driving sprocket;
an arcuate portion extending over the small driving sprocket and endless chain at the sprocket for defining the pivot of the keeper about the sprocket; and
an elastic portion extending from the arcuate portion for biasing the chain-contacting tongue with respect to the one piece chain keeper.

11. The chain and sprocket transmission system of claim 9 and further including:
a chain keeper lock for enabling the pivoting chain keeper to be pivotally locked to a position of rotation about the small driving sprocket whereby the chain-contacting tongue elastically biased with respect to the keeper can be adjusted in its bias with respect to the endless chain.

12. The chain and sprocket transmission system of claim 9 and further including:
a clutch connected between the small driving sprocket and the high-speed, low-horsepower motor for absorbing dynamic shock transmitted from the large driven sprocket.

13. The chain and sprocket transmission system according to claim 9 and including:
a lubricant source disposed in the chain keeper for lubricating the endless chain.

14. The chain and sprocket transmission system according to claim 13 and wherein:
the lubricant source is disposed in a tensioned portion of the chain keeper between the large driven sprocket and the small driving sprocket.

15. In a chain and sprocket transmission system for a small all-terrain vehicle having a high-speed, low-horsepower motor coupled to a small-diameter vehicle driving wheel where the transmission system includes;
a small driving sprocket directly driven by the high-speed, low-horsepower motor;
a large driven sprocket coaxially rotating with the small-diameter vehicle driving wheel; and
an endless chain having links for encircling in a loop the small driving sprocket and the large driven sprocket;
the improvement in the transmission system comprising:
a one-piece chain keeper for pivoting over the small driving sprocket having a chain-contacting tongue elastically biased with respect to the keeper for tensioning the chain at the idle chain linkage toward the inside of the loop between the small driving sprocket and the large driven sprocket.

16. In the chain and sprocket transmission system according to claim 15 and wherein:
the one-piece chain keeper pivots over the small driving sprocket and chain encircling the small driving sprocket.

17. In the chain and sprocket transmission system according to claim 15 and wherein:
the one-piece chain keeper includes a groove for guiding the chain relative to the small driving sprocket and the large driven sprocket.

18. In the chain and sprocket transmission system according to claim 15 and wherein:
the one-piece chain keeper includes an aperture overlying the chain for enabling lubricant to flow to the chain.

19. In the chain sprocket transmission system according to claim 15 and wherein:
the one-piece chain keeper includes a transverse aperture remote from the small driving sprocket for enabling the one-piece chain keeper to be adjustably pivoted with respect to the pivot over the small driving sprocket.

20. In the chain and sprocket transmission system according to claim 19 and wherein:
the transverse aperture remote from the small driving sprocket is adapted to a lock for holding the one-piece chain keeper in fixed angular relationship with respect to the small driving sprocket.

21. A chain tensioning device for a chain and sprocket transmission system for a small all-terrain vehicle having a small driving sprocket directly driven by a high-speed, low-horsepower motor, a large driven sprocket coaxially rotating with a small-diameter vehicle driving wheel, and an endless chain having links for encircling in a loop the small driving sprocket and the large driven sprocket, the chain tensioning device for biasing the chain to the inside of the loop around at least the small driving sprocket comprising:
a one-piece chain keeper;
an arcuate portion defined by the one-piece chain keeper for pivoting over the small driving sprocket; and
a chain-contacting tongue elastically biased over the arcuate portion with respect to the one-piece chain keeper for tensioning the chain at the idle chain linkage toward the inside of the loop between the small driving sprocket and the large driven sprocket.

22. The chain tensioning device for a chain and sprocket transmission system for a small all-terrain vehicle according to claim 21 wherein:
the one-piece chain keeper includes a groove for guiding the chain relative to the small driving sprocket and the large driven sprocket.

23. The chain tensioning device for a chain and sprocket transmission system for a small all-terrain vehicle according to claim 21 wherein:
the one-piece chain keeper includes an aperture overlying the chain for enabling lubricant to flow to the chain.

24. The chain tensioning device for a chain and sprocket transmission system for a small all-terrain vehicle according to claim 21 wherein:
the one-piece chain keeper includes a transverse aperture remote from the small driving sprocket for enabling the one-piece chain keeper to be adjustably pivoted with respect to the pivot over the small driving sprocket.

25. The chain tensioning device for a chain and sprocket transmission system for a small all-terrain vehicle according to claim 24 wherein:
the transverse aperture remote from the small driving sprocket is concentric about the arcuate portion defined by the one-piece chain keeper to form a lock aperture for holding the one-piece chain keeper in fixed angular relationship with respect to the small driving sprocket.
